(19) United States
(12) Patent Application Publication
(10) Pub. No.: US 2008/0175196 A1
(43) Pub. Date: Jul. 24, 2008

(54) Method of enhancing continuous packet connectivity in a wireless communications system and related apparatus

(75) Inventor: Yu-Chih Jen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited, Tortola (VG)

(21) Appl. No.: 12/010,281

(22) Filed: Jan. 23, 2008

Related U.S. Application Data
(60) Provisional application No. 60/886,292, filed on Jan. 23, 2007.

(51) Int. Cl. H04Q 7/00; H04J 3/00

(52) U.S. Cl. 370/329; 370/345; 370/335

(57) ABSTRACT

A method for enhancing discriminability of orders in a network of a wireless communications system includes activating a High Speed Downlink Package Access function, and transmitting a control order corresponding to the High Speed Downlink Package Access function multiple times.

### CROSS REFERENCE TO RELATED APPLICATIONS

This application claims the benefit of U.S. Provisional Application No. 60/886,292, filed on Jan. 23, 2007 and entitled “Method and Apparatus to realize Continuous Packet Connectivity and improve discontinuous transmission and reception”, the contents of which are incorporated herein by reference.

### BACKGROUND OF THE INVENTION

1. Field of the Invention

The present invention relates to a method of enhancing continuous packet connectivity in a wireless communications system and related apparatus, and more particularly, to a method and related communications apparatus to enhance discriminability of orders, to timely adjust the configuration of CPC or operating modes, and to enhance CPC.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting at the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve uplink/downlink transmission rate. For HSDPA and HSUPA, the 3rd Generation Partnership Project (3GPP) provides a Continuous Packet Connectivity (CPC) protocol specification, which includes features that, for user equipments (UEs) in CELL_DCH state, aim to significantly increase the number of packet data users for a cell, reduce the uplink noise rise and improve the achievable download capacity for VoIP.

For an HSDPA UE, physical channels include a high speed physical downlink shared channel (HS-PDSCH), for transferring payload data, and a high speed physical control channel (HS-DPCCH) for uploading an acknowledgement/negative acknowledgement (ACK/NACK) and a channel quality identifier (CQI). As for the media access control (MAC) layer of the HSDPA UE, a MAC-hs entity utilizes a transport channel of High Speed Downlink Shared Channel (HS-DSCH) for receiving data from the physical layer. In addition, a shared control channel for HS-DSCH (HS-SCCH) is used as a physical downlink channel, responsible for transmission of control signals corresponding to HS-DSCH, such as demodulation information.

For an HSUPA UE, physical channels includes two uplink channels: an enhanced dedicated transport channel dedicated physical data channel (E-DPDCH), for transferring payload data, and an E-DCH dedicated physical control channel (E-DPCCH) for transmission of control signals, such as retransmission numbers. Furthermore, a bundle of downlink physical channels are employed in the HSUPA system and used for transmitting control signals associated with grants, ACKs and etc. The downlink physical channels include E-DCH relative grant channel (E-RGCH), E-DCH absolute grant channel (E-AGCH), E-DCH HARQ acknowledgement indicator channel (E-HICH) and fractional dedicated physical channel (F-DPCH). As for the MAC layer of the HSUPA UE, a MAC-e/es entity utilizes a transport channel of enhanced dedicated transport channel (E-DCH) for transmitting MAC packet data to the physical layer with supporting a transmission time interval (TTI) of 10 milliseconds (ms) or 2 ms.

For CELL_DCH state, CPC operation defines an active state and an inactive state. For any data channels (ex. E-DCH), the active state represents that there are data packets transmitted on the data channels. For any control channels (ex. HS-DPCCH), the active state represents that there are data packets transmitted on the data channels corresponding to the control channels, such as HS-PDSCH corresponding to HS-DPCCH. On the contrary, for any data channels, the inactive state represents that there are no data packets transmitted on the data channels. For any control channels, the inactive state represents that there are no data packets transmitted on the data channels corresponding to the control channels.

According to the CPC protocol specification, discontinuous uplink transmission (uplink DTX) is a mechanism where control signals are transmitted on the uplink control channels according to defined discontinuous patterns during the inactive state of corresponding uplink data channels in order to maintain signal synchronization and power control loop with less control signaling. The uplink control channels include a normal DPCCH in addition to the abovementioned uplink control channels of HSUPA and HSDPA.

Moreover, discontinuous uplink reception (uplink DRX) of CPC is utilized to control the UE to transmit E-DCH in specific time interval and has to be configured with uplink DTX. If there has been no E-DCH transmission for a configurable number of transmission time intervals (ex. the interval of UE_Inactivity_Threshold), a radio network controller (RNC) can configure the UE to restrict the start of E-DCH transmission to a MAC_DTX_cycle pattern. UE_DTX_DRX_Offset is also used in uplink DRX, allowing the UEs to have different E-DCH start time.

Furthermore, discontinuous downlink reception (downlink DRX) of CPC is configured by the RNC and allows the UE to restrict the downlink reception times in order to reduce power consumption. When the downlink DRX is enabled, the UE is not required to receive physical downlink channels except for several specific situations.

In addition, CPC includes an HS-SCCH less operation, which is a special mode of HSDPA operation for reducing HS-SCCH overhead for a hybrid automatic repeat request (HARQ) process, thereby reducing UE power consumption. Under this mode, the first HS-DSCH transmission of the HARQ process corresponding to small transport blocks (TBs) on pre-defined HS-DSCH is performed without accompaniment of HS-SCCH signaling, and the HARQ retransmissions corresponding to the first HS-DSCH transmission are accompanied with the HS-SCCH signaling if the retransmissions are needed. Accordingly, the UE needs blind decoding for TB data of the first transmission based on predefined TB size and channel coding set. If blind decoding is success, the UE reports ACK to the base station, also known Node-B, through HS-SCCH; otherwise, the UE reports nothing and waits for retransmission initiated by the Node-B. In order to combine the first transmission with the subsequent retransmissions, the HS-SCCH transmits required control signals of physical channel coding set, TB size, UE identity, a pointer and etc., where the pointer notify the UE of the TTI where the previous transmission has been performed. In addition, The UE can report ACK or NACK for the retransmission, and the retransmission is restricted to two times. The first and second retransmissions can be asynchronous with respect to the first transmission, and with respect to each other. The accompanying HS-SCCH follows the same timing relationship with the HS-PDSCH transmission as legacy transmissions do.

In order to activate or deactivate CPC functions, a HS-SCCH type 2 is introduced in the prior art, which defines operations of CRC (Cyclic Redundancy Check) when performs retransmission via HS-PDSCH and HS-SCCH, and Layer 1 commands for activating or deactivating DRX/DTX. To achieve the above-mentioned functions, the prior art uses orders x_{ord,1} and x_{ord,2} to control activation/deactivation of DRX/DTX. For example, [x_{ord,1} x_{ord,2}]=[0 0] represents deactivation of both DRX and DTX; [x_{ord,1} x_{ord,2}]=[0 1] represents deactivation of DRX and activation of DTX; [x_{ord,1} x_{ord,2}]=[1 1] represents activation of both DRX and DTX. Since DRX can only be activated after DTX is activated, [x_{ord,1} x_{ord,2}]=[1 0] represents system error. However, the prior art does not specify UE behavior when [x_{ord,1} x_{ord,2}]=[1 0], and may cause subsequent transmission miss or unexpected behavior. In addition, the orders [x_{ord,1} x_{ord,2}] could be wrong if CRC failed.

### SUMMARY OF THE INVENTION

According to the present invention, a method for enhancing discriminability of orders in a network of a wireless communications system comprises activating a High Speed Downlink Package Access function, and transmitting a control order corresponding to the High Speed Downlink Package Access function multiple times.

According to the present invention, a method for enhancing a CPC function in a UE of a wireless communications system comprises triggering a special order reorganization mode for corresponding an invalid value of a command byte, utilized for activating or deactivating a discontinuous reception function or a discontinuous transmission function of the CPC function, to a specified operation or an indication, and triggering the specified operation or identifying the indication after receiving the command byte having the invalid value.

According to the present invention, a method for enhancing a CPC function in network of a wireless communications system comprises a UE triggering a special order reorganization mode for corresponding an invalid value of a command byte, utilized for activating or deactivating a discontinuous reception function or a discontinuous transmission function of the CPC function, to a specified operation or an indication, and sending the command byte having the invalid value to the UE when triggering the UE to perform the specified operation.

According to the present invention, a communications device for enhancing discriminability of orders in a wireless communications system comprises a control circuit for realizing functions of the communications device, a central processing unit installed in the control circuit for executing a program code to operate the control circuit, and a memory coupled to the central processing unit for storing the program code. The program code comprises activating a High Speed Downlink Package Access function, and transmitting a control order corresponding to the High Speed Downlink Package Access function multiple times.

According to the present invention, a communications device for enhancing a CPC function in a wireless communications system comprises a control circuit for realizing functions of the communications device, a central processing unit installed in the control circuit for executing a program code to operate the control circuit, and a memory coupled to the central processing unit for storing the program code. The program code comprises triggering a special order reorganization mode for corresponding an invalid value of a command byte, utilized for activating or deactivating a discontinuous reception function or a discontinuous transmission function of the CPC function, to a specified operation or an indication, and triggering the specified operation or identifying the indication after receiving the command byte having the invalid value.

According to the present invention, a communications device for enhancing a CPC function in a wireless communications system comprises a control circuit for realizing functions of the communications device, a central processing unit installed in the control circuit for executing a program code to operate the control circuit, and a memory coupled to the central processing unit for storing the program code. The program code comprises a UE triggering a special order reorganization mode for corresponding an invalid value of a command byte, utilized for activating or deactivating a discontinuous reception function or a discontinuous transmission function of the CPC function, to a specified operation or an indication, and sending the command byte having the invalid value to the UE when triggering the UE to perform the specified operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 to FIG. 5 are flowchart diagrams of processes according to embodiments of the present invention.

### DETAILED DESCRIPTION

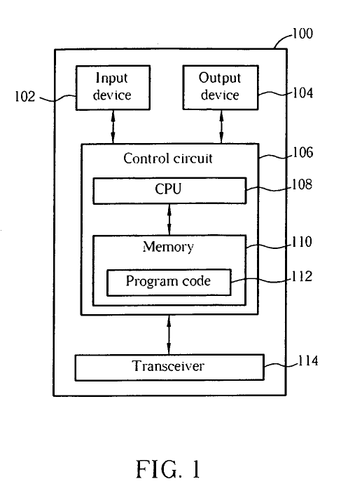

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a High Speed Package Access (HSPA) system of the third generation (3G) mobile communications system, LTE system, or other related communications system, and can be user or network equipment.

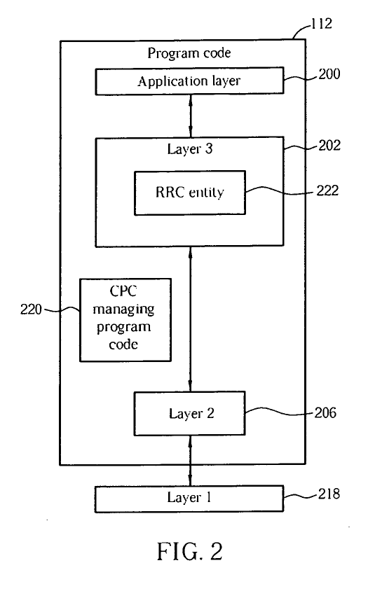

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 includes a radio resource control (RRC) entity 222, which is used for controlling the Layer 1 218 and the Layer 2 206. In addition, when the communications device 100 implements a user equipment, the RRC entity 222 can change an RRC state according to system requirements or radio conditions, to switch between an RRC_IDLE state and an RRC_CONNECTED state. The RRC_CONNECTED state can be CELL_PCH, URA_PCH, CELL_FACH or CELL_DCH state in 3G system.

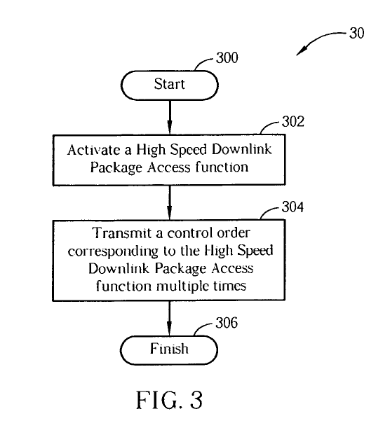

As mentioned above, for UEs in CELL_DCH state, the network can configure CPC to significantly increase the number of packet data users for a cell, reduce the uplink noise rise and improve the achievable download capacity for VoIP. CPC includes mechanisms of uplink DTX, uplink DRX, downlink DRX, and HS-SCCH less operation, for reducing UE power consumption. In such a situation, the embodiment of the present invention provides a CPC managing program code 220 to avoid system malfunction. Please refer to FIG. 3, which illustrates a schematic diagram of a process 30 according to an embodiment of the present invention. The process 30 is utilized for enhancing discriminability of orders in a network of a wireless communications system, and can be compiled into the CPC managing program code 220. The process 30 comprises the following steps:
Step 300: Start.
Step 302: Activate a High Speed Downlink Package Access function.
Step 304: Transmit a control order corresponding to the High Speed Downlink Package Access function multiple times.
Step 306: Finish.

According to the process 30, after the HSDPA function is activated, the embodiment of the present invention transmits the control order multiple times. That is, the network can retransmits the control order without receiving ACKs, so as to prevent the UE from misunderstanding the control order, and enhance discriminability of the orders.

Preferably, the embodiment of the present invention can transmit the control order multiple times via HS-SCCH following a scheduled transmission pattern, so as to enhance discriminability of the orders, and prevent misunderstanding due to CRC failure, which may cause waste of power, loss of packets, and interference of uplink messages.

Therefore, via the process 30, the embodiment of the present invention can enhance discriminability of the control orders.

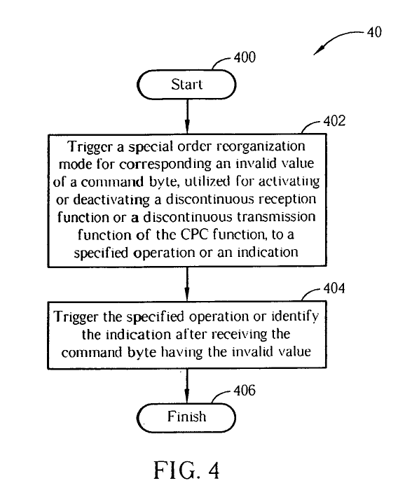

Please refer to FIG. 4, which illustrates a schematic diagram of a process 40. The process 40 is utilized for enhancing CPC in a UE of a wireless communications system, and can be compiled into the CPC managing program code 220. The process 40 comprises the following steps:
Step 400: Start.
Step 402: Trigger a special order reorganization mode for corresponding an invalid value of a command byte, utilized for activating or deactivating a discontinuous reception function or a discontinuous transmission function of the CPC function, to a specified operation or an indication.
Step 404: Trigger the specified operation or identify the indication after receiving the command byte having the invalid value.
Step 406: Finish.

According to the process 40, the embodiment of the present invention defines a special order reorganization mode, utilized for corresponding an invalid value of a command byte to a specified operation or an indication, where the command byte is utilized for activating or deactivating a discontinuous reception function or a discontinuous transmission function of the CPC function, such as [x_{ord,1} x_{ord,2}] mentioned above. In other words, in the special order reorganization mode, the invalid value of [x_{ord,1} x_{ord,2}], [1 0], is corresponding to the specified operation. In such a situation, after the UE activates the special order reorganization mode, [x_{ord,1} x_{ord,2}]=[1 0] represents activation of the specified operation. Basically, the embodiment of the present invention defines the invalid value of the command byte to another special order or indication.

The specified operation can be utilized for adjusting configuration of CPC or switching the operating modes. For example, after the special order reorganization mode is triggered, if [x_{ord,1} x_{ord,2}]=[1 0] represents deactivation of HS-SCCH less operation, when the UE receives [x_{ord,1} x_{ord,2}]=[1 0], the UE deactivates HS-SCCH less operation. By the same token, after the special order reorganization mode is triggered, if [x_{ord,1} x_{ord,2}]=[1 0] represents switching configuration of CPC (e.g. from less operation to normal operation, when the UE receives [x_{ord,1} x_{ord,2}]=[1 0], the UE switches the configuration of CPC.

Moreover, after the special order reorganization mode is triggered, if the UE receives the command byte having the invalid value, the UE can report an ACK to indicate the receiving status. Otherwise, if the special order reorganization mode is not triggered, if the UE receives the command byte having the invalid value, the UE can discard the command byte and report a NACK.

Therefore, via the process 40, the embodiment of the present invention corresponds the invalid value of the command byte to the specified operation, so as to switch the configuration of CPC or operating modes.

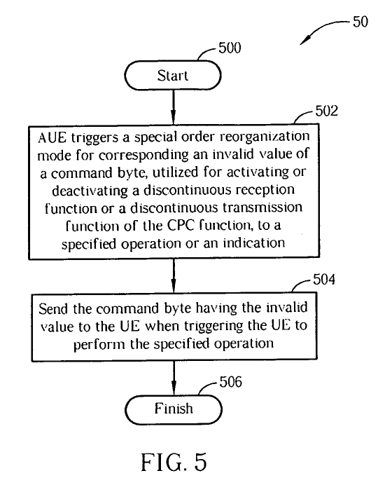

Please refer to FIG. 5, which illustrates a schematic diagram of a process 50. The process 50 is utilized for enhancing CPC in a network of a wireless communications system, and can be compiled into the CPC managing program code 220. The process 40 comprises the following steps:
Step 500: Start.
Step 502: AUE triggers a special order reorganization mode for corresponding an invalid value of a command byte, utilized for activating or deactivating a discontinuous reception function or a discontinuous transmission function of the CPC function, to a specified operation or an indication.
Step 504: Send the command byte having the invalid value to the UE when triggering the UE to perform the specified operation.
Step 506: Finish.

According to the process 50, after the UE triggers the special order reorganization mode, if the network wants to trigger the UE to perform the specified operation, the network can send a command byte having the invalid value. As a result, the UE can switch operation accordingly.

The process 50 is cooperated with the process 40, and will not be further narrated for clarity.

In summary, in CPC, the embodiment of the present invention transmits the control order multiple times, to enhance discriminability of the orders, and corresponds an invalid value of a command byte to a specified operation or an indication via the special order reorganization mode, to timely adjust the configuration of CPC or operating modes, and to enhance CPC.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing discriminability of orders in a network of a wireless communications system comprising:
activating a High Speed Downlink Package Access function; and
transmitting a control order corresponding to the High Speed Downlink Package Access function multiple times.

2. The method of claim 1, wherein transmitting the control order corresponding to the High Speed Downlink Package Access function multiple times is transmitting the control order corresponding to the High Speed Downlink Package Access function multiple times via a shared control channel for a High Speed Downlink Shared Channel.

3. The method of claim 1, wherein transmitting the control order corresponding to the High Speed Downlink Package Access function multiple times is transmitting the control order predefined times following a scheduled transmission pattern.

4. A method for enhancing a Continuous Packet Connectivity, called CPC hereinafter, function in a user equipment, called UE hereinafter, of a wireless communications system comprising:
triggering a special order reorganization mode for corresponding an invalid value of a command byte, utilized for activating or deactivating a discontinuous reception function or a discontinuous transmission function of the CPC function, to a specified operation or an indication; and
triggering the specified operation or identifying the indication after receiving the command byte having the invalid value.

5. The method of claim 4, wherein the specified operation is deactivating a less operation of the CPC function.

6. The method of claim 4 further comprising outputting an acknowledgment signal after receiving the command byte.

7. The method of claim 4 further comprising:
deactivating special order reorganization mode; and
discarding another command byte having the invalid value after receiving the another command byte.

8. The method of claim 7 further comprising outputting a negative acknowledgement signal.

9. The method of claim 4, wherein the specified operation is switching a configuration of the CPC function.

10. A method for enhancing a Continuous Packet Connectivity, called CPC hereinafter, function in network of a wireless communications system comprising:
a user equipment, called UE hereinafter, triggering a special order reorganization mode for corresponding an invalid value of a command byte, utilized for activating or deactivating a discontinuous reception function or a discontinuous transmission function of the CPC function, to a specified operation or an indication; and
sending the command byte having the invalid value to the UE when triggering the UE to perform the specified operation.

11. The method of claim 10, wherein the specified operation is deactivating a less operation of the CPC function.

12. The method of claim 10 further comprising retransmitting the command byte to the UE when an acknowledgement signal is not received from the UE within a specified period after sending the command byte.

13. The method of claim 10, wherein the specified operation is switching a configuration of the CPC function.

14. A communications device for enhancing discriminability of orders in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
activating a High Speed Downlink Package Access function; and
transmitting a control order corresponding to the High Speed Downlink Package Access function multiple times.

15. The communications device of claim 14, wherein transmitting the control order corresponding to the High Speed Downlink Package Access function multiple times is transmitting the control order corresponding to the High Speed Downlink Package Access function multiple times via a shared control channel for a High Speed Downlink Shared Channel.

16. The communications device of claim 14, wherein transmitting the control order corresponding to the High Speed Downlink Package Access function multiple times is transmitting the control order predefined times following a scheduled transmission pattern.

17. A communications device for enhancing a Continuous Packet Connectivity, called CPC hereinafter, function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
triggering a special order reorganization mode for corresponding an invalid value of a command byte, utilized for activating or deactivating a discontinuous reception function or a discontinuous transmission function of the CPC function, to a specified operation or an indication; and
triggering the specified operation or identifying the indication after receiving the command byte having the invalid value.

18. The communications device of claim 17, wherein the specified operation is deactivating a less operation of the CPC function.

19. The communications device of claim 17, wherein the program code further comprises outputting an acknowledgment signal after receiving the command byte.

20. The communications device of claim 17, wherein the program code further comprises:
deactivating special order reorganization mode; and
discarding another command byte having the invalid value after receiving the another command byte.

21. The communications device of claim 20 wherein the program code further comprises outputting a negative acknowledgement signal.

22. The communications device of claim 17, wherein the specified operation is switching a configuration of the CPC function.

23. A communications device for enhancing a Continuous Packet Connectivity, called CPC hereinafter, function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
a user equipment, called UE hereinafter, triggering a special order reorganization mode for corresponding an invalid value of a command byte, utilized for activating or deactivating a discontinuous reception function or a discontinuous transmission function of the CPC function, to a specified operation or an indication; and
sending the command byte having the invalid value to the UE when triggering the UE to perform the specified operation.

24. The communications device of claim 23, wherein the specified operation is deactivating a less operation of the CPC function.

25. The communications device of claim 23, wherein the program code further comprises retransmitting the command byte to the UE when an acknowledgement signal is not received from the UE within a specified period after sending the command byte.

26. The communications device of claim 23, wherein the specified operation is switching a configuration of the CPC function.
